(19) United States
(12) Patent Application Publication
(10) Pub. No.: US 2004/0236965 A1
(43) Pub. Date: Nov. 25, 2004

(54) System for cryptographical authentication

(76) Inventor: Petri Krohn, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/635,911

(22) Filed: Aug. 7, 2003

(30) Foreign Application Priority Data
May 20, 2003 (GB) 0311621.7

(51) Int. Cl. H04L 9/00

(52) U.S. Cl. 713/201; 713/175

(57) ABSTRACT

A communication system includes a first node, a second node and, at least one intermediate node between said first and second nodes. The first and second nodes are arranged to be in communication. The first and second nodes have a first security association and one of the intermediate nodes and the second node have a second security association. The first security association authenticates the second node to the first node and the second security association authenticates the at least one intermediate node to the second node.

### BACKGROUND OF THE INVENTION

1. Field of the Invention

The invention relates to a communication method and in particular but not exclusively to a method for use in wireless communication system such as a cellular wireless system.

2. Description of the Related Art

Wireless cellular communication networks are generally widely known. In such a system the total area covered by the communication network is divided into cells. Each cell is provided with a base transceiver station which is arranged to communicate with mobile stations or other user equipment in the cell associated with the base transceiver station.

In these known systems, a channel is allocated to one user. This channel can be considered to be a circuit switched channel, in other words the user is connected to the base station via this channel, and uses this channel while data is passes from user equipment to the base transceiver station. For example in the case of the GSM (Global System for Mobile Communications) standard, a user is allocated a given frequency band and a particular timeslot in that frequency band. In other communication systems such as the code division multiple access (CDMA) systems more than one user equipment element may be assigned to the same physical resource, but may be distinguished from each other by use of an added code sequence. Data passing through such systems, to an external server passes through a specified path from the user equipment, to the cell base transceiver station, to a base station controller, to a gateway, before travelling to the external server.

Computer networks external to the wireless communications system, such as the network of computers known as the Internet communicates using data in packet form. These packets are presented to the network, which then pass from network node to network node until they reach their destination. The actual path taken by the network packets is not considered to be important and sequential packets may not always take the same path from transmit node to receive node.

Several wireless communication protocols attempt or propose either true wireless packet communications or packet communication emulation within a switched network. One example are GPRS (General Packet Radio System) networks, which may be implemented either as part of a GSM network or as part of a CDMA system.

Two elements of security within a packet switched network are client/server identification and client/server data protection. The client is defined as one of the two end nodes of the communication link, typically the node requesting a service of some type. The server is defined as the second of the two end nodes of the communication link, and is typically the node attempting to supply a service of some type.

The definition of client/server identification and client/server data are contained within the protocol known as the Secure Socket Layer (SSL) protocol. The SSL protocol defines a series of steps within which the two end nodes communicate with each other using both their identity and a cipher code in order to protect any further data communication between the two nodes.

Clients of mobile communications networks are often connected to the Internet and web services through proxy gateways. This arrangement unfortunately exposes some limitations in the SSL protocol. One of the problems associated with the use of the SSL protocol within a mobile communications network and mobile proxy gateways is that the SSL connection from the server to the mobile communications network gateway (the node from which the mobile communications network interfaces with the external network) does not extend to the client at the same time. Therefore data traffic between the client and the gateway is not protected according to the SSL protocol. In other words there is no end-to-end authentication between client and server.

Terminating the SSL connection at the gateway results in the client not being able to authenticate a service provider. Any links to SSL related web pages (identifiable by their https:// URL (Universal Resource Locator) rather than the normal unprotected URL http://) would have to be modified by the gateway in order to be displayed on the mobile station.

The mobile device itself may be used in order to produce a shadow client attack. A shadow client attack is where a second client is able to assume the identity of the first client in order to gain access to services, which are then credited to the first client falsely.

Another approach would be to create a “proxy” SSL connection at the gateway. Each SSL connection initiated by a client would cause the gateway to create a first proxy-SSL connection from client to the gateway, and a second SSL connection from the gateway to the server, which would be associated with the client connection at the gateway. These two SSL connection proposals have a disadvantage in that the end points of the connection need to correctly identify each other; however, the client and the server receive the digital identity of the gateway and therefore reject the communication.

The SSL protocol itself provides a method to authenticate a client. A digital certificate is stored at the client. The security procedure involves a handshake between the client and server, a request for the certificate and an authentication procedure. However this arrangement has the disadvantage that there is no simple way of delivering a certificate to the user, or of authenticating a secret key generated by the user. A common way of delivering a certificate to a client is to send it to him on a floppy disk personally or via the mail. Clearly this is disadvantageous.

A single sign on procedure has also been proposed, an example of which is the Microsoft passport scheme. A “passport” is used to sign on to other services. This involves the users identity be propagated to other sites.

### SUMMARY OF THE INVENTION

The invention provides a communication system which includes a first node, a second node and, at least one intermediate node between the first and second nodes. The first and second nodes are arranged to be in communication and the first and second nodes have a first security association. One of the intermediate nodes and the second node have a second security association. The first security association authenticates the second node to the first node and the second security association authenticates the at least one intermediate node to the second node.

At least one of the first and second security associations may include presenting at least one certificate to a respective one of the nodes for authentication.

At least one certificate may include a cryptographic certificate.

The certificate may include a X.509 certificate.

At least one intermediate node may inspect information sent between the first and second nodes.

At least one of intermediate nodes may modify information sent between the first and second nodes.

The first node may be attached to a wireless network.

The first node may be attached to a packet switched network.

The first node may be attached to a network operating in accordance with the GPRS standard.

The first node may be connected to wireless user equipment.

The first node may be one a plurality of first nodes connected to the wireless user equipment.

The first node may include a client device.

At least one of the first and second security associations may include encryption.

At least one of the intermediate nodes may be arranged to pass data packets from at least one the first node to at least one the second node and/or from at least one the second node to at least one the first node.

The one intermediate node may be arranged in a network gateway node.

The network gateway node may include one of a GGSN and/or a SGSN.

The second node may be connected to the gateway node.

The client device may include a computer, user equipment, mobile station, or personal digital assistant.

The second node may include a server.

The second node may be arranged to provide a service to the first node.

The first node may be arranged to send a first connection message to the second node.

The first connection message may be a Transmission Control Protocol (TCP) connection message.

The first node may be arranged to send a hello message to the at least one intermediate node.

The hello message may be a SSL handshake message.

The at least one intermediate node may be arranged to make a copy of at least part of the hello message.

The at least one intermediate node may be arranged to send the hello message to the second node.

The second node may be arranged to send a hello message to the at least one intermediate node.

The at least one intermediate node may be arranged to send a handshake message to the second node in response to receiving the hello message from the second node.

The second node may be arranged to respond to the handshake message.

The response may be a SSL handshake message.

The handshake message sent to the second node may be a SSL handshake message.

The handshake messages may be arranged to create the second security association.

The handshake message sent by the one of intermediate nodes may include a client certificate.

At least one of the intermediate nodes may be arranged to create the client certificate only when requested.

At least one of the intermediate nodes may be arranged to retrieve the client certificate from a storage device.

The at least one intermediate node and the second node may be arranged to generate at least one key to encrypt information sent there between, the at least one key being used in the second security association.

The first node and the second node may be arranged to generate at least one key to encrypt information sent there between, the at least one key being used in the first security association.

The at least one intermediate node may be arranged to create the key only when requested.

The at least one intermediate node may be arranged to retrieve the key from a storage device.

The key may be arranged to be dependent on the client certificate.

At least one the client certificate may certify a first node known to the at least one intermediate node.

At least one the client certificate may certify the holder of a specified resource.

The specified resource may be one of an International Mobile Station Identity (IMSI) telephone number and a Mobile Station Integrated Service Digital Network (MSISDN) telephone number.

At least one the client certificate may authorize the second node to charge the holder of the specified resource for the services used or purchased.

The second security association may be established before the first security association.

According to a second embodiment, the invention provides a system which includes a first node, an intermediate node, and a second node. The intermediate node is arranged to store security information for the first node. The security information is arranged to be used to provide security for a connection between the intermediate node and the second node.

The security includes a tunnelled connection, an authenticated connection and/or an encrypted connection.

A common protocol may be used between the first and second nodes.

According to a third embodiment of the invention there is provided an intermediate node for use in a system between a first node and a second node. The intermediate node is arranged to store and/or generate security information relating to the first node.

The security information may include a security certificate, at least one security key, at least one public key and/or at least one private key.

At least one the intermediate node may be arranged to calculate a message digest dependent on a received data packet and a secret key.

At least one the intermediate node may add the message digest to the received data packet prior to transmitting.

The message digest may be arranged to be bit-wise added to the received data packet.

The message digest may be arranged to be concatenated to the end of the received data packet.

The received data packet may be arranged to be encrypted by the secret key prior to being added to the message digest.

The message digest may be arranged to be added to the last n bits of the received data packet.

The message digest may be arranged to be calculated dependent on the bits before the last n bits of the received data packet.

The at least one intermediate node may be arranged to remove the message digest from the data packet.

The at least one intermediate node may be arranged to decrypt the data packet using the secret key.

The second security association may be dependent on data within the hello message sent from the second node.

The first node may include an SSL Client node.

According to a fourth embodiment, the invention provides a method for a communication system comprising a first end node, a second end node and at least one intermediate node between the first and second end nodes. The method includes the steps of applying a first security protocol to information sent between the first and second nodes, and applying a second security protocol to information sent between one of the intermediate nodes and the second node, to or from the first node.

According to a fifth embodiment of the invention there is provided a method for authenticating data packets in an intermediate node. The method includes the steps of receiving a data packet from a first node, generating a secret key; generating a message digest dependent on the data packet and the secret key; generating a further data packet dependent on the data packet and the message digest; and transmitting the further data packet to a second node.

The step of generating the further packet may include the step of bit wise adding the message digest to a selection of bits from the data packet.

The step of generating the further packet may include the step of concatenating the message digest to the data packet.

The data packet may be encrypted by the secret key prior to the step of generating the message digest.

The data packet may be encrypted by the secret key prior to the step of generating the further data packet.

The data packet may be M bits long.

The selection of bits may be the last n bits of the data packet.

The generation of the message digest may be dependent on the first M-n bits of the data packet only.

The method described above may further include the steps of: receiving a data packet from the second node; generating a modified data packet by removing a message digest from the data packet from the second node; transmitting the modified data packet to the first node.

One advantage of the invention is that the invention may provide a method which provides a more secure communication system capable identifying a client at a service provider securely and without the requirement of creating several different and independent SSL connections.

### BRIEF DESCRIPTION OF THE DRAWINGS

For a better understanding of the invention and how the same may be carried into effect, reference will now be made, for example only, to the accompanying drawings in which:

FIG. 1 shows a schematic view of a typical cell layout in a wireless cellular network in which the embodiments of the invention can be implemented;

FIG. 2 shows a schematic view of a typical zero sign-on client server relationship within a communications environment;

FIG. 3 shows a schematic view of a typical single sign-on client server relationship within a communications environment;

FIG. 4 shows a schematic view of a single sign-on client server relationship as shown in FIG. 3 wherein a wireless communication GPRS link connects the client to the identity provider and wherein embodiments of the invention can be implemented;

FIG. 5 shows a schematic view of a client server relationship as shown in FIG. 4 supporting an additional network of clients, wherein embodiments of the invention can be implemented;

FIG. 6 shows a schematic view of a client server relationship as seen in FIG. 5 according an embodiment of the invention;

FIG. 7 shows a flow diagram of the steps for establishing a communications link according the invention; and

FIG. 8 shows examples for a coding sequence for identifying the path between a client and server, which can be implemented in embodiments of the invention.

### DETAILED DESCRIPTION OF THE PREFERRED EMBODIMENTS

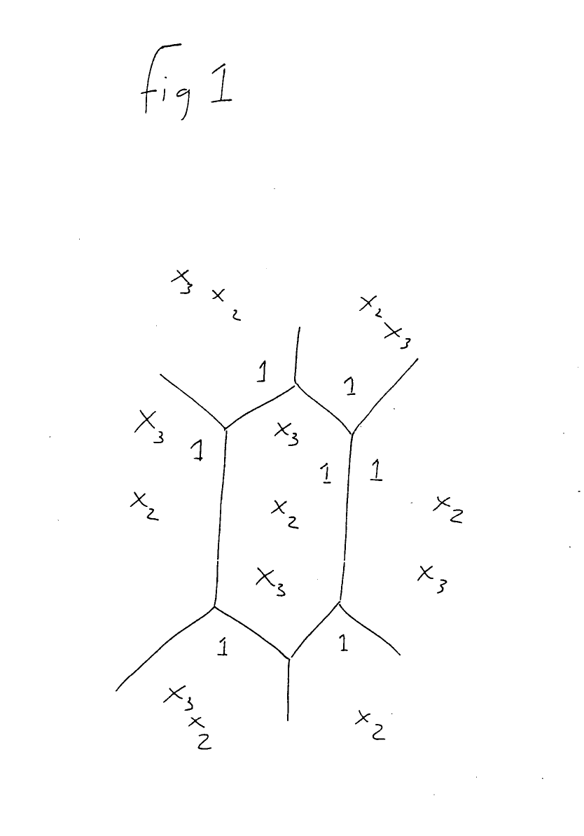

Reference is made to FIG. 1 which shows a part of a cellular telecommunications network 4 in which embodiments of the invention can be implemented. The area covered by the network is divided into a plurality of cells 1, one of which is shown in totality and the six surrounding cells are partially shown in FIG. 1. Each cell 1 has associated therewith a base transceiver station 2. The base transceiver station 2 is arranged to communicate with mobile terminals or other user equipment 3 located in the area associated with the base transceiver station 2. These cells may overlap partially or totally. In some systems, the cells may have a different shape to that illustrated. In some embodiments the base stations may communicate with mobile stations outside their associated cell. Furthermore communication may occur between mobile stations without requiring the intermediate step of communicating via the base station.

According to one embodiment of the invention, a mobile communication system does not follow the traditional end-to-end communication model. Instead in this example, the data is required to be routed through a specific base station/gateway path before entering a communications network.

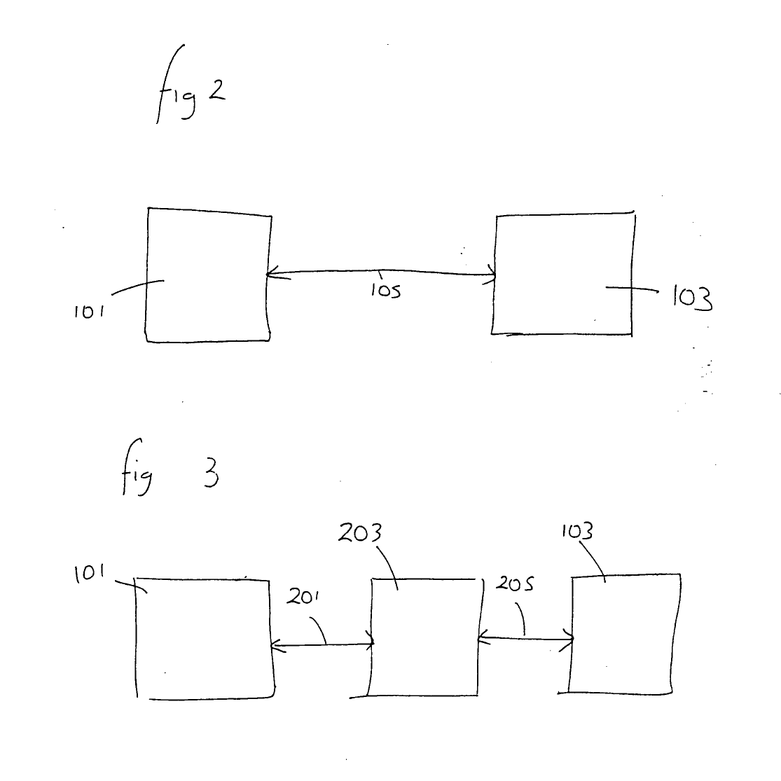

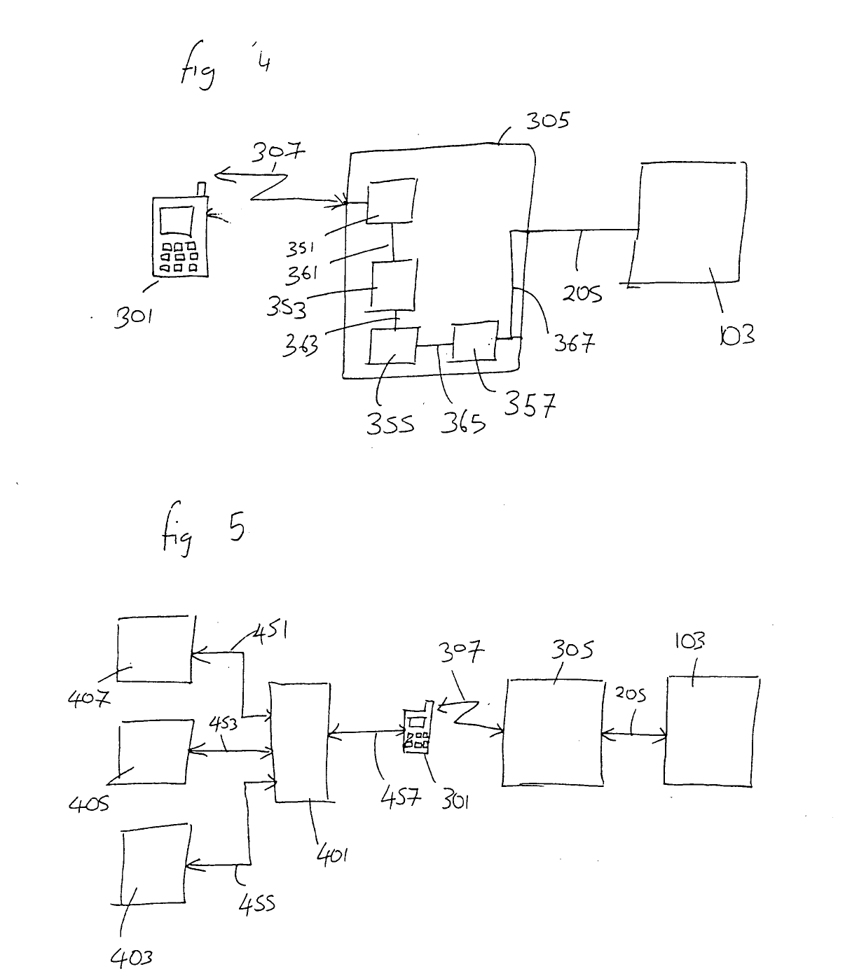

Reference is now made to FIG. 2 which shows a schematic view of a known client server relationship. The client server relationship includes a client device 101, a server device 103 and a communications link 105. The communications link 105 connects the client device 101 to the server device 103 in order that packets of data may be passed between the two.

The client device 101 is typically a personal computer (PC), but may also be a personal digital assistant (PDA), or any other device requesting a service across a network. The server device 103 is typically a server computer capable of delivering a service which the client device 101 is requesting. The communications link 105 is typically a series of connected network nodes of the computer network known as the Internet. The communications link passes the packets of data transmitted by the client device 101 and the server device 103.

According to one embodiment of the invention, users of the client device are not required identify themselves to the server before beginning a connection. As the communications link 105 between the client device 101 and the server device 103 is not typically a direct connection a means for securing the communications between the client device 101 and the server device 103 is required. In other words a typical data packet is received and then retransmitted towards the final destination by several intermediate network nodes each of which being capable of reading the packets of data. Although a single network node may not necessarily read the whole message which may include several packets, enough packets may be read in order to construct information relating to the server or client. This information can be credit card numbers or authorization codes used in banking systems.

In order to establish a secure link between the two devices a protocol known as the secure socket layer (SSL) protocol is used. The SSL protocol describes a series of processes.

The SSL protocol is widely known and used on the World Wide Web for securing communication between clients and servers.

The SSL protocol uses a combination of public key and symmetric key encryption. These encryption methods are themselves widely known in the field of cryptography. Symmetric key encryption is much faster than public key encryption, but due to the nature of public key encryption, the public key system provides a better authentication technique.

An SSL session always begins with an exchange of messages called a SSL handshake. The handshake allows the server to authenticate itself to the client using public key techniques, then allows the client and server to cooperate in the creation of symmetric keys used for rapid encryption, decryption and tamper detection during the session that follows. Optionally the handshake also allows the client to authenticate itself to the server.

The SSL protocol is designed primarily to provide an end-to-end security system.

FIG. 4 shows a schematic diagram of the process of requesting a service, whereby the client device is a mobile communication device connecting to a server device 303. In the examples of the invention discuss herein, the communications are based on the SSL protocol. In this embodiment the mobile device 301 uses a GPRS gateway network. The system includes a mobile device or user equipment 301, a wireless communications link 307, a mobile communications network/gateway 305, a communications link 205 and a service device 103. The gateway knows the client identity. The mobile device 301, which may be a mobile station capable of also being used for mobile telephony, a personal data organizer (PDA), a personal computer (PC), a laptop or other user equipment, is a known communications device capable of transmitting and receiving data according to the mobile communications link protocols known in the art.

The mobile communications network/gateway 305, includes a base transceiver station (BTS) 351, a base transceiver station controller (BTSC) 353, a serving GPRS support node (SGSN) 355, a gateway GPRS support node (GGSN), a data link 361, an IP network link 363, an IP based GPRS backbone 365, and an internet link 367.

The base transceiver station 351 is connected to the base transceiver station controller 353 via the communications link 361. The base station controller is connected to the SGSN 355 via the IP network link 363. The SGSN 355 is connected to the GGSN 357 via the IP based GPRS backbone link 365 and the GGSN 353 is connected to the Internet link 309 via the Internet link 367.

In such a system the mobile device 301 communicates over the wireless link 307 to the base station 351. The base station 351 passes the communications data via the communications data link 361 to the base station controller 353. The base station controller communicates to the SGSN and the GGSN nodes via the communication links 363 and 365. The GGSN then connects to the Internet link 205 and the server device 103 via the Internet link 367. The reverse path is required to be followed in order that data transmitted by the server device reach the mobile device 301. Therefore in such a system there is a specific and required path for which the communication link must take place.

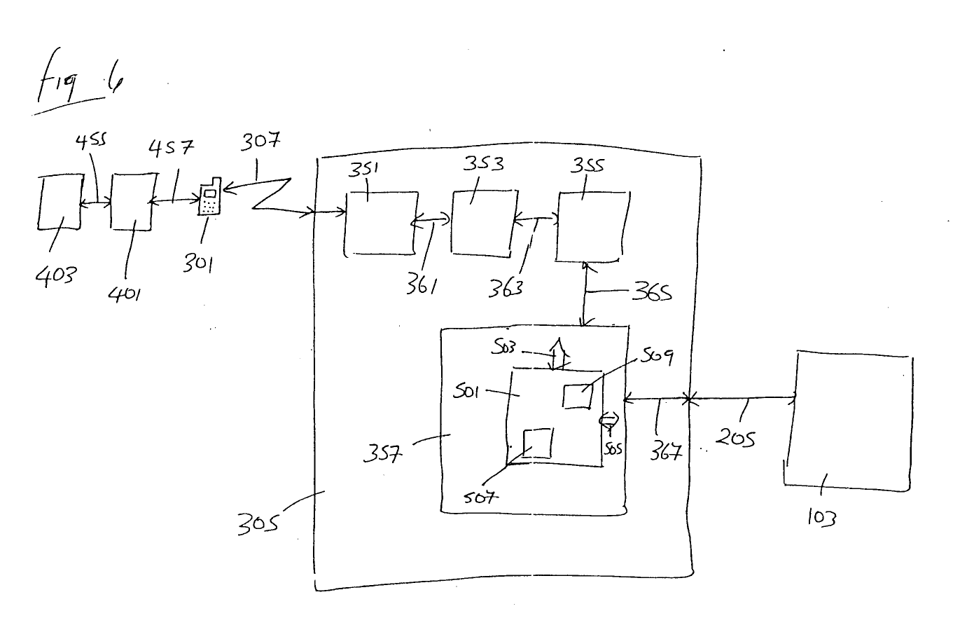

FIG. 5 shows a system similar to that shown in FIG. 4, wherein the mobile device is itself connected to a network of computers. This system includes some of the same units of FIG. 5 but further includes an additional communications link 457, a network address translation computer host 401, a plurality of client devices 403, 405, 407, and a plurality of communications links 451, 453, 455. The plurality of client devices 403, 405, 407 are connected via the plurality of communications links 451, 453, 455 to the network address translation computer host 401. The network address translation computer host 401 is itself connected to the mobile device 301 via the additional communications link 457. The communication link 457 in the embodiments of the invention may be a wireless infrared link. This link on other embodiments of the invention may be a wireless radio-frequency link, or in further embodiments of the invention may be a cable link.

In such a system, the client devices request and receive data via the mobile communications system. The client devices 403,405,407 send and receive messages to and from the network address translation computer 401. The network address translation computer 401 includes a look-up table which enables data to be transmitted to and received by the correct client device. The additional communications link 457 communicates the data between the network address translation computer 401 and the mobile device 301. The mobile device codes and decodes the data according to the modulation methods used to communicate with the wireless communications network 305, across the wireless communications link 307. The wireless communications network 305 then passes the data across the communications link 205 to the server device 103

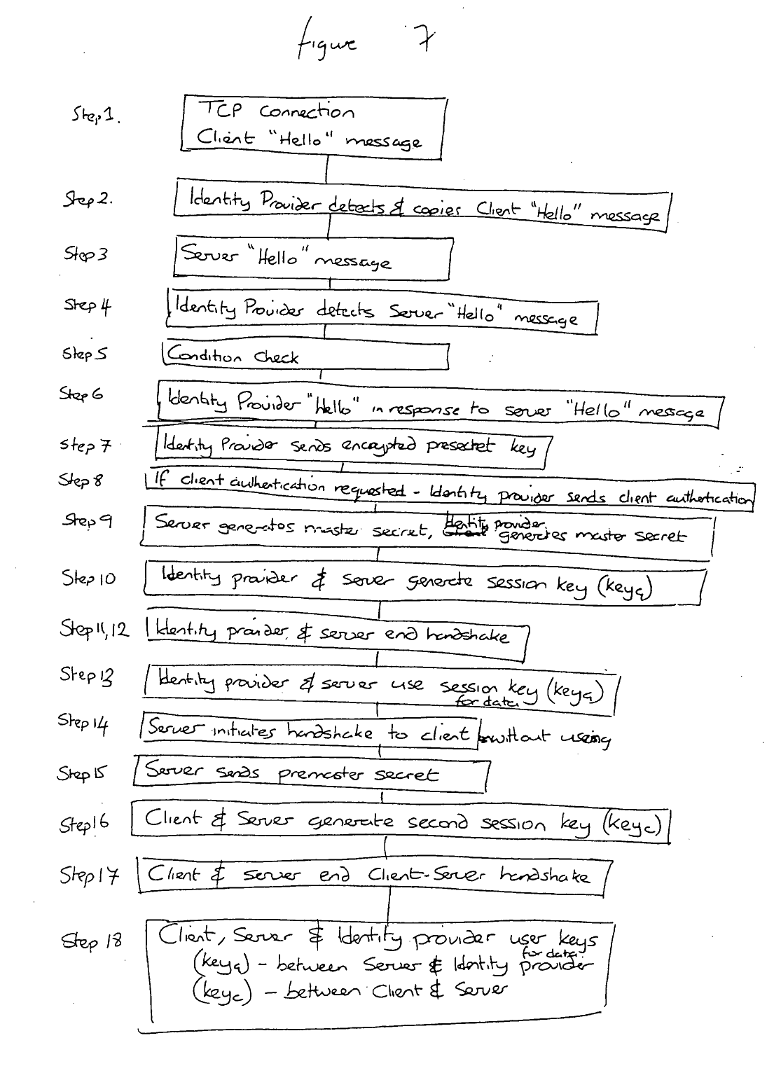

FIG. 6 shows a communications system in which embodiments of the invention may be implemented. The communications system shows the communications path between a single client device 403 to the server device 103.

The same references as used in FIG. 5 are used where the same items occur in FIG. 6. This system includes the client device 403, a communications link 455, a network address translator computer 401, a communications link 457, a mobile device 301, a mobile communications link 307, a mobile communications network 305, a communications link 205, and a server device 103. The network address translator performs the role of a data router. In this embodiment, the network address translator device is shown in such a manner that the network address translator is used only where the connection of one client device to the mobile device is optional.

These components are connected together in a manner similar to that described above, wherein the client device 403 is connected to the network address translator 401 via the communications link 455. The network address translator 401 is connected to the mobile device 301 via the communications link 457. The mobile device 301 is connected to the mobile communications network 305 via the mobile communications link 307. The mobile communications network is connected to the server device 103 via the communications link 205.

As mentioned above the wireless communications network 305 includes a base transceiver station 351, a base transceiver station controller 353, the SGSN 355 and the GGSN 357 connected together by communications links 361,363,365 as also described above.

The GGSN further includes an identity provider device 501.

The identity provider device 501 in other embodiments of the invention may be located within the wireless communications network 305 but outside of the GGSN 357.

The identity provider device 501, includes a first data port 503, a second data port 505, a processor 507 and a memory unit 509.

In a first embodiment of the invention the first data port 503 receives and transmits data received from or transmitted to the client device, whereas the second data port is arranged to receive and transmit data received from or transmitted to the server device.

In other embodiments of the invention the first or second data port may be arranged to receive and transmit data associated with either or both the client or server devices.

The processor 507 receives the data passing through the GGSN associated with the client device 403 and the server device 103 and determines whether a multi-tier SSL connection is required to the created.

The memory device 509 is used by the identity provider 501 to store data received dependent on the actions of the processor.

In other embodiments of the invention, the processor 507 may store information external to the identity provider 501.

In a multi-tier SSL connection there are multiple security associations for one SSL session or connection. Thus a first security association occurs between the identity provider and the server device. A second security association is created between the server device and the client device. The second security association can be considered to form a layer on top of the first security association.

If the processor 507 determines that client device 403 is requesting a service from a server device 103 a series of steps for creating a secure communications link between the client device and the server device. These steps establish a multi-tier SSL protocol connection. In such a system an initial SSL security association is created between the identity provider and the server device. A second SSL security association is then created between the server device and the client device.

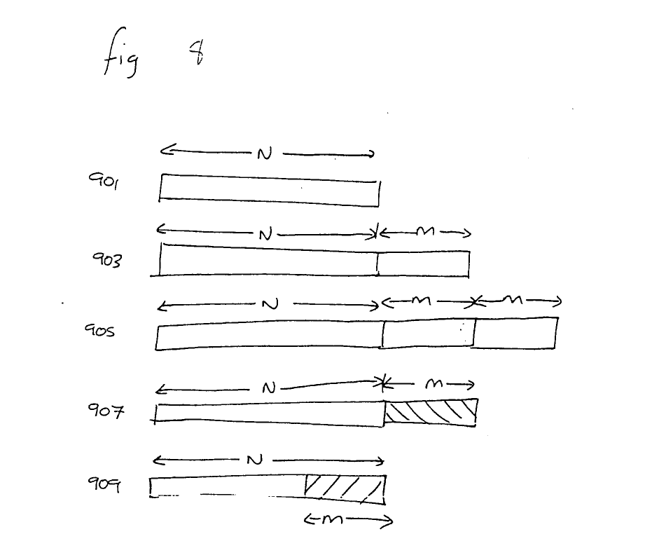

With reference to FIG. 6 and FIG. 7, one example of a process of creating a multi-tier SSL is detailed below.

The client device 403 transmits an initial TCP (transport control protocol) connection message to the server device 103 which passes via the network address translator 401, and the mobile communications network 305. The connection message is followed by an initial SSL handshake message (the client “hello” message). The message includes the SSL version number, some random data, and an identifier data block which is unique to the user operating the client device, and known to the mobile communications network. The client “hello” message further includes additional information required by the server to create a secure link. This connection message is sent from the client device 403 to the identity provider 501.

The identity provider 501 detects the client “hello” message and makes a copy of it in the memory device 509. The “hello” message is forwarded to the server device 103 via the communications link 205.

The server device 103 receives the client “hello” message and responds with its own server “hello” message. The server “hello” message includes a SSL version number, cipher settings, some randomly generated data, and other information the client needs to communicate with the server over the multi-tiered SSL connection. In other embodiments of the invention the server may also send an identification data block or a copy of the server's digital certificate, and if the client is requesting a server resource that requires client authentication, requests the client's certificate. The server “hello” is sent to the mobile communications network 305.

The server “hello” message is detected by the identity provider 501 and examined by the processor 507.

If the conditions for multi-tier SSL security are not met, the server “hello” is passed directly on to the client and the link between the two defaults to the prior art method of linking between the two. In other words if the server device does not fully support or does not indicate that it supports multi-tier SSL security, fails an authentication test to prove the identity of the server device, fails to request client authentication, the gateway does not recognize the connection as a SSL connection or the client and the server “hello” does not match the SSL, no additional security is possible and a single layer SSL protocol can be set up between the GGSN and the server device 103. One indication that the gateway can use to recognize a SSL connection is the server port number.

If server device supports multi-tiered SSL, and has requested client authorization the identity provider sends a second handshake message to the server device 103. As the identity provider 501 has stored a copy of the original client “hello” message, the first security association between the identity provider and the server can be formed as if the identity provider had sent the massage.

Using all of the data generated in the handshake so far, the identity provider 501 (with the cooperation of the server, depending on the cipher being used) creates a pre-master secret key for the session, encrypts the pre-master secret with the server devices public key, and sends the encrypted pre-master secret to the server device.

If the server device has requested client device authentication (an optional step in the handshake), the identity provider signs another piece of data that is unique to this handshake and known by both the identity provider 501 and server device 103. In this case the identity provider presents a client certificate identifying the client. This client certificate and the associated secret key can be obtained from a database, or they can be created on demand. This certificate can be authenticated by the identity provider with a secret key known to the server. The identity provider 501 sends both the signed data and the client certificate to the server device along with the encrypted pre-master secret key. Note, that if client authentication was not requested, there is no need for the multi-tier SSL and the identity provider never enters the handshake.

If the client/user cannot be authenticated, the session is terminated. If the client/user can be successfully authenticated, the server device uses its private key to decrypt the pre-master secret key, and performs a series of steps (which the identity provider 501 also performs, starting from the same pre-master secret key) to generate the master secret key.

Both the identity provider 501 and server device 103 use the master secret to generate the session keys, which are symmetric keys to encrypt and decrypt information exchanged during the SSL session between 501 and 103 and to verify its integrity—that is, to detect any changes in the data between the time it was sent and the time it was received over the SSL connection.

The identity provider 501 sends a message to the server device 103 informing the server device 103 that future messages from the identity provider 501 for a particular client will be encrypted with the session key (Key_{G}). The identity provider 501 then sends a separate (encrypted) message indicating the identity provider 501 portion of the handshake is finished.

The server device 103 sends a message to the identity provider 501 informing the identity provider 501 that future messages from the server device 103 will be encrypted with the session key (Key_{G}). The server device 103 then sends a separate (encrypted) message indicating that the server device 103 portion of the handshake is finished.

After the identity provider 501, the server device 103 handshake is completed. The identity provider 501 authenticates (and encrypts and decrypts) all subsequent data traffic from the client device 403 through the identity provider 501 with this key (Key_{G}).

The server device now enters a second handshake, this time with the original client device. While the second phase of the handshake is in progress the session key (Key_{G}) is not used and the handshake is not encrypted. The server responds to the original client “hello” message and this response is passed back to the client through the identity provider 501. Once again using all data generated in the handshake so far, the client device 403 (with the cooperation of the server device 103, depending on the cipher being used) creates the pre-master secret key for the security association, encrypts the pre-master secret with the server device public key and sends the encrypted pre-master secret key to the server.

As the client has been already successfully authenticated, the server uses its private key to decrypt the pre-master secret key, and performs a series of steps (which the client device also performs, starting from the same pre-master secret key) to generate the master secret key.

Both the client device 403 and server device 103 use the master secret key to generate the second session key (Key_{c}), which are symmetric keys to encrypt and decrypt information exchanged during the SSL session and to verify its integrity—that is, to detect any changes in the data between the time it was sent and the time it was received over the SSL connection.

The client device 403 and the server device 103 send messages to each other informing each other that future messages will be encrypted with the second session key. Both the client device 403 and the server device 103 then send a separate (encrypted) message indicating the handshake procedure between the two is finished.

At this point the complete handshake ends with the last finished message from the server. After this message has been passed all three parties start encrypting communication. At this point the server encrypts and authenticates all outgoing data with two keys, first with Key_{C} and secondly with Key_{G}. The identity provider 501 encrypts and decrypts all data passing through with Key_{G}. The client device encrypts and decrypts all data with Key_{C}.

In a further embodiment of the invention the identity provider initiates authentication and encryption after the first phase of the handshake, wherein throughout the second handshake phase the handshake data passed from identity provider 501 to the server device 103 is encrypted.

By using this two layer SSL security not only is security achieved between the mobile communications network 305 (and more specifically the GGSN 357) and the server device 103 using the first tier of the SSL for security using session encryption key Key_{G}, but the communication path between the user operating the client device 403 and the server device 301 via the identity provider is also achieved using the session encryption key Key_{C}.

In further embodiments of the invention public keys rather than generated session keys may be used for encryption and decryption.

The addition of the extra tier of the SSL also solves the problems raised earlier, for instance both the identity of the specific user operating a client is authenticated initially at the identity provider 501. This authentication is then passed to the server device before the establishment of a second handshake between the server device and the client device.

The identity provider, as well as the client and server devices, can in some embodiments use identification certificates such as those defined by the X.509 standard. The X.509 standard defines that a digitally signed statement from one entity is certifiable by a trusted third party as coming from the originator.

The X.509 certificate is defined by a series of fields, such as; certificate version, serial number, signature algorithm identifier, name of the issuer, the validity period and the public key of the issuer.

The possibility of shadow attacks is avoided by the provision of end-to-end security.

Finally as a SSL link is possible there is no requirement to pre-process information at the GGSN in order that the mobile system is capable of receiving and reading secure WWW site information.

The computing cost of double encryption of data may be significant, when compared to the over computational cost. In such cases in further embodiments of the invention it is possible to omit the encryption.

In some embodiments of the invention, client data message is passed to the identity provider. The identity provider then signs the message by appending data called the message digest to the end of each of the data packets to be sent. With reference to FIG. 8 an initial packet of information of n-bits long 901 is appended with a further m-bits of data. The appended data provides an identification mark unique to the identity provider. This packet 903 is then directed towards the server device 103.

The server device 103 receives the packet 903 of information and extracts the message digest in the last m-bits of data. From this information it is possible to determine from which identity provider the message originated.

If the packet does not pass directly from the GGSN to the network but instead passes through a series of GGSN before reaching a internet gateway, each of the identity provider elements within the GGSN sign the packet 905 by adding their specific message digests.

This message digest can be formed by a cryptographic algorithm, a “hash function” from the message content and a secret key known to both the server and identity provider.

In such a system it is possible for the server device to detect the exact path of the originating packet and authenticate this by extracting the last m-bits from the packet and using a simple look up table stored within or externally to the server device 103 to identify an identity provider 501. This is repeated until no more signatures are identified. The specific path can then be examined to determine whether it is trusted and therefore allow a secure connection to be created between the server device and the originating identity provider 501.

In other embodiments of the invention other signature techniques may be used. Additional signatures may not further append the message digest bits but may instead be combined by some reversible process known in the art, for example XOR'ing the last m-bits 907.

In other embodiments of the invention the original addition of a digital signature is not created by appending the original data packet to be transmitted but be combining the message digest signature to the last m-bits of the data packet by some reversible process 909. Further signatures are added by further combining the already signed data packet with additional signatures.

In the embodiments of the invention, the authentication may be based on an identity of the mobile station—for example the mobile stations ISDN or the like.

Preferred embodiments of the invention have been described in the context of a mobile communications network. However it should be appreciated that embodiments of the invention can be used in other suitable application, for example in an Internet based environment with two different domains. Embodiments of the invention can be used in the context of any access network, for example an Ethernet or an IP based routed network using an address space allocated for private networks,

Service providers use authenticating and tunnelling protocols to connect and authenticate their clients. Possible protocols include point to point protocol (PPP), point to point protocol over Ethernet (PPPoE), point to point tunnelling protocol (PPTP), IP security (IPSec) and GPRS tunnelling protocol (GTP). The use of these protocols gives the service provider knowledge of the client's identity. This information can be used in the embodiments of the invention to enable the service provider to act as an Identity provider and authenticate the end user client in any SSL based internet based service.

Embodiments of the invention can be used for authentication at a border of a network or part of a network.

Embodiments of the invention are arranged so that the gateway is arranged to generate the private and/or public keys and the certificates for each client accessing the gateway. The same or different keys may be used each time a user accesses a service.

1. A communication system comprising:
a first node;
a second node and;
at least one intermediate node between said first and second nodes;
wherein said first and second nodes are arranged to be in communication and said first and second nodes have a first security association and one of said at least one intermediate node and said second node have a second security association; and
wherein said first security association authenticates said second node to said first node and said second security association authenticates said at least one intermediate node to said second node.

2. A system as claimed in claim 1, wherein at least one of said first and second security associations comprise presenting at least one certificate to a respective one of said nodes for authentication.

3. A system as claimed in claim 2, wherein said at least one certificate comprises a cryptographic certificate.

4. A system as claimed in claim 3, wherein said certificate comprises an X.509 certificate.

5. A system as claimed in claim 1, wherein said at least one intermediate node inspects information sent between said first and second nodes.

6. A system as claimed in claim 1, wherein said at least one of intermediate nodes modifies information sent between said first and second nodes.

7. A system as claimed in claim 1, wherein said first node is attached to a wireless network.

8. A system as claimed claim 1, wherein said first node is attached to a packet switched network.

9. A system as claimed in claim 1, wherein said first node is attached to a network operating in accordance with a General Packet Radio System standard.

10. A system as claimed in claim 1, wherein said first node is connected to wireless user equipment.

11. A system as claimed in claim 10, wherein said first node comprises one of a plurality of first nodes connected to said wireless user equipment.

12. A system as claimed in claim 1, wherein said first node comprises a client device.

13. A system as claimed in claim 1, wherein at least one of said first and second security associations comprises encryption.

14. A system as claimed in claim 1, wherein said one of said at least one said intermediate node is configured to pass data packets from at least one of said first node to at least one of said second node and from at least one of said second node to at least one of said first node.

15. A system as claimed in claim 1, wherein said at least one intermediate node is arranged in a network gateway node.

16. A system as claimed in claim 15, wherein the network gateway node comprises one of a gateway GPRS support node and a serving GPRS support node.

17. A system as claimed in claim 15, wherein said second node is connected to said gateway node.

18. A system as claimed in claim 12, wherein said client device comprises a computer, user equipment, mobile station, or personal digital assistant.

19. A system as claimed in claim 1, wherein said second node comprises a server.

20. A system as claimed in claim 1, wherein said second node is configured to provide a service to said first node.

21. A system as claimed in claim 1, wherein the first node is configured to send a first connection message to the second node.

22. A system as claimed in claim 21, wherein said first connection message comprises a Transmission Control Protocol connection message.

23. A system as claimed in claim 1, wherein the first node is configured to send a hello message to the at least one intermediate node.

24. A system as claimed in claim 23, wherein said hello message comprises a Secure Socket Layer protocol handshake message.

25. A system as claimed in claim 23, wherein the at least one intermediate node is configured to make a copy of at least a part of said hello message.

26. A system as claimed in claim 23, wherein said at least one intermediate node is configured to send said hello message to the second node.

27. A system as claimed in claim 1, wherein the second node is configured to send a hello message to the said at least one intermediate node.

28. A system as claimed claim 27, wherein said at least one intermediate node is configured to send a handshake message to the second node in response to receiving said hello message from said second node.

29. A system as claimed in claim 28, wherein said second node is configured to respond to said handshake message.

30. A system as claimed in claim 28, wherein said response comprises a Secure Socket Layer protocol handshake message.

31. A system as claimed in claim 28, wherein said handshake message sent to the second node comprises a Secure Socket Layer protocol handshake message.

32. A system as claimed in claim 28, wherein said handshake messages are configured to create said second security association.

33. A system as claimed in claim 28, wherein said handshake message sent by said one of said at least one intermediate node comprises a client certificate.

34. A system as claimed in claim 33, wherein said one of said at least one intermediate node is configured to create said client certificate when requested.

35. A system as claimed in claim 33, wherein said one of said at least one intermediate node is configured to retrieve said client certificate from a storage device.

36. A system as claimed in claim 1, wherein said at least one intermediate node and said second node are configured to generate at least one key to encrypt information sent between said at least one node and said second node, said at least one key being used in said second security association.

37. A system as claimed in claim 1, wherein said first node and said second node are configured to generate at least one key to encrypt information sent there between said first node and said second node, said at least one key being used in said first security association.

38. A system as claimed in claim 36, wherein said at least one intermediate node is configured to create said at least one key only when requested.

39. A system as claimed in claim 36, wherein said at least one intermediate node is configured to retrieve said at least one key from a storage device.

40. A system as claimed in claim 36, wherein said at least one key is configured to be dependent on a client certificate.

41. A system as claimed in claim 33, wherein at least one said client certificate certifies a known node which is known to said at least one intermediate node.

42. A system as claimed in claim 33, wherein said client certificate certifies a holder of a specified resource.

43. A system as claimed in claim 42, wherein said specified resource comprises one of an International Mobile Station Identity telephone number and a Mobile Station Integrated Service Digital Network telephone number.

44. A system as claimed in claim 42, wherein at least one said client certificate authorizes said second node to charge said holder of said specified resource for services used or purchased.

45. A system as claimed in claim 1, wherein said second security association is established before said first security association.

46. A system comprising:
a first node;
an intermediate node; and
a second node, wherein said intermediate node is configured to store security information for said first node, said security information being configured to be used to provide security for a connection between the intermediate node and said second node.

47. A system as claimed in claim 46, wherein said security comprises at least one of tunnelled connection, an authenticated connection and an encrypted connection.

48. A system as claimed in claim 46, wherein a common protocol is used between said first and second nodes.

49. An intermediate node for use in a system between a first node and a second node, said intermediate node being configured to at least one of to store and to generate security information relating to said first node.

50. A node as claimed in claim 49, wherein the security information comprises at least one of a security certificate, at least one security key, at least one public key and at least one private key.

51. A system as claimed in claim 49, wherein at least one intermediate node is configured to calculate a message digest based on a received data packet and a secret key.

52. A system as claimed in claim 51, wherein said at least one intermediate node adds said message digest to said received data packet prior to transmission.

53. A system as claimed in claim 52, wherein said message digest is configured to be bit-wise added to the received data packet.

54. A system as claimed in claim 52, wherein said message digest is configured to be concatenated to an end of the received data packet.

55. A system as claimed in claim 52, wherein said received data packet is configured to be encrypted by said secret key prior to being added to said message digest.

56. A system as claimed in claim 52, wherein said message digest is configured to be added to a final n bits of the received data packet.

57. A system as claimed in claim 52, wherein said message digest is configured to be calculated based on bits before the final n bits of the received data packet.

58. A system as claimed in claim 51, wherein said at least one intermediate node is configured to remove said message digest from said data packet.

59. A system as claimed in claim 51, wherein said at least one intermediate node is configured to decrypt said data packet using said secret key.

60. A system as claimed in claim 27, wherein said second security association is based on data within said hello message sent from said second node.

61. A system as claimed claim 1, wherein said first node comprises an Secure Socket Layer Client node.

62. A method for a communication system comprising a first end node, a second end node and at least one intermediate node positioned between said first and second end nodes, comprising the steps of:
applying a first security protocol to information sent between said first and second nodes; and
applying a second security protocol to information sent between one of said intermediate nodes and said second node, wherein the information is then sent to or from said first node.

63. A method for authenticating data packets in an intermediate node comprising the steps of:
receiving a data packet from a first node;
generating a secret key;
generating a message digest based on said data packet and said secret key;
generating a further data packet based on said data packet and said message digest; and
transmitting said further data packet to a second node.

64. The method of claim 63, wherein said step of generating said further packet comprises the step of bit wise adding the message digest to a selection of bits from said data packet.

65. The method of claim 63, wherein said step of generating said further packet comprises the step of concatenating the message digest to said data packet.

66. The method of claim 63, further comprising the step of encrypting said data packet by said secret key prior to said step of generating said message digest.

67. The method of claim 63, further comprising the step of encrypting said data packet by said secret key prior to said step of generating said further data packet.

68. The method of claim 63, wherein said receiving step comprises receiving said data packet being M bits long.

69. The method of claim 68, wherein said receiving step comprises selecting the last n bits of said data packet.

70. The method of claim 69, wherein said generating the message digest step depends on a first M-n bits of said data packet.

71. The method of claim 63, further comprising the steps of:
receiving a data packet from said second node;
generating a modified data packet by removing the message digest from said data packet from said second node; and
transmitting said modified data packet to said first node.
